(19) United States
(12) Patent Application Publication
(10) Pub. No.: US 2011/0006989 A1
(43) Pub. Date: Jan. 13, 2011

(54) Pointing Device

(75) Inventor: Song Hak Ji, Seoul (KR)

Correspondence Address: DORITY & MANNING, P.A., POST OFFICE BOX 1449, GREENVILLE, SC, 29602-1449, US

(73) Assignee: Song Hak JI, Seoul (KR)

(21) Appl. No.: 12/919,585

(22) PCT Filed: Feb. 25, 2009
(86) PCT No.: PCT/KR2009/000896

§ 371 Date: Aug. 26, 2010

(30) Foreign Application Priority Data
Mar. 4, 2008 (KR) 10-2008-0020175

(51) Int. Cl. G09G 5/08

(52) U.S. Cl. 345/163

(57) ABSTRACT

Disclosed is a pointing device that includes a curved supporter which including a curved surface; a pointing unit placed over the curved supporter and sliding along the curved surface of the curved supporter; and a sensor sensing movement of the pointing unit, in which the movement of the pointing unit is displayed on a screen, corresponding to extent that the pointing unit slides along the curved surface of the curved supporter. With this, there is provided a pointing device that can be installed within a limited space such as a mobile device or a notebook computer requiring thin thickness and enable delicate work since it can move along the curved surface.

### BACKGROUND OF THE INVENTION

(a) Field of the Invention

The present invention relates to a pointing device, and more particularly to a pointing device that can be used in a desktop computer, a notebook computer, a mobile device, etc,

(b) Description of the Related Art

In general, a mouse is one of input devices for moving a mouse pointer displayed on a monitor.

The mouse includes a ball mouse, a sensor mouse or the like that has been used for a desktop computer, and a touchpad mouse or the like that has been used for a portable computer such as a notebook computer or a mobile device. As a built-in mouse for a small body such as the portable computer, the ball mouse was used in an early stage, but the touchpad mouse has been ordinarily used at present.

The main reason why the touchpad mouse is usually mounted is because the body of the portable computer is small.

In the case of the ball mouse, the mouse pointer can be moved by rotating a ball, and it is thus convenient to work for delicate movement. However, movement of the mouse itself is needed to move the mouse pointer, and therefore a certain space has to be saved.

As the mobile device such as a cellular phone, a personal digital assistant (PDA), etc. has recently become smaller, it is difficult for the ball mouse to be built in the mobile device due to the size and the like limitation of the ball. Even if a small ball is employed, there is a problem that the ball has to rotate many times since a moving distance of the mouse pointer on a monitor per rotation of the ball becomes relatively shorter as much as the small size of the ball.

Meanwhile, the ball of the ball mouse is exposed to the outside of the mouse, i.e., to the exterior, so that foreign materials can be attached to the surface of the ball. At this time, a sensor for sensing the movement of the mouse is placed outside the ball, and thus has difficulty in exactly sensing the movement of the ball.

Due to the foregoing problems, the touchpad mouse has recently been ordinarily used for the portable computer such as a notebook computer. The touchpad mouse is more advantageous than the ball mouse in light of space utilization since it senses movement of fingers being in broad contact with a touch pad, but lags behind the ball mouse in efficiency of delicate movement.

### SUMMARY OF THE INVENTION

Accordingly, the present invention is conceived to solve the foregoing problems, and an aspect of the present invention is to provide a pointing device that can be installed within a limited space.

Another aspect is to provide a pointing device that can move a mouse pointer minutely.

Still another aspect is to provide a pointing device suitable for a small mobile device since it can move a mouse pointer minutely within a limited space.

An exemplary embodiment of the present invention provides a pointing device including: a curved supporter which includes a curved surface; a pointing unit which is placed over the curved supporter and slides along the curved surface of the curved supporter; and a sensor which senses movement of the pointing unit, the movement of the pointing unit being displayed on a screen, corresponding to extent that the pointing unit slides along the curved surface of the curved supporter.

The pointing device may further include a housing main body in which the curved supporter, the pointing unit and the sensor are embedded.

The sensor may sense movement of a pointing moving part that is a bottom of the pointing unit.

The pointing unit or the curved supporter may include a magnetic unit or a spring so that the pointing unit returns to an original position after moved by sliding along the curved surface of the curved supporter.

The curved supporter may include a sensor receiving part to accommodate the sensor.

The sensor receiving part may include one of a hole and a groove.

The pointing device may further include a control module provided to display the movement of the pointing unit on the screen, corresponding to the extent that the pointing unit slides along the curved surface of the curved supporter.

### BRIEF DESCRIPTION OF THE DRAWINGS

FIG. 1 is an exploded perspective view of a pointing device according to a first exemplary embodiment of the present invention;

FIG. 2 is a cross-section view of the pointing device according to the first exemplary embodiment of the present invention;

FIG. 3 is an assembled cross-section view of the pointing device according to the first exemplary embodiment of the present invention; and

FIGS. 4 through 6 show operation of the pointing device according to the first exemplary embodiment of the present invention.

### DETAILED DESCRIPTION OF THE EMBODIMENTS

For description, like elements will be described using like numerals representatively in a first exemplary embodiment, and only elements different from those of the first exemplary embodiment will be described in other embodiments.

Hereinafter, a pointing device according to a first exemplary embodiment of the present invention will be described in more detail with reference to accompanying drawings.

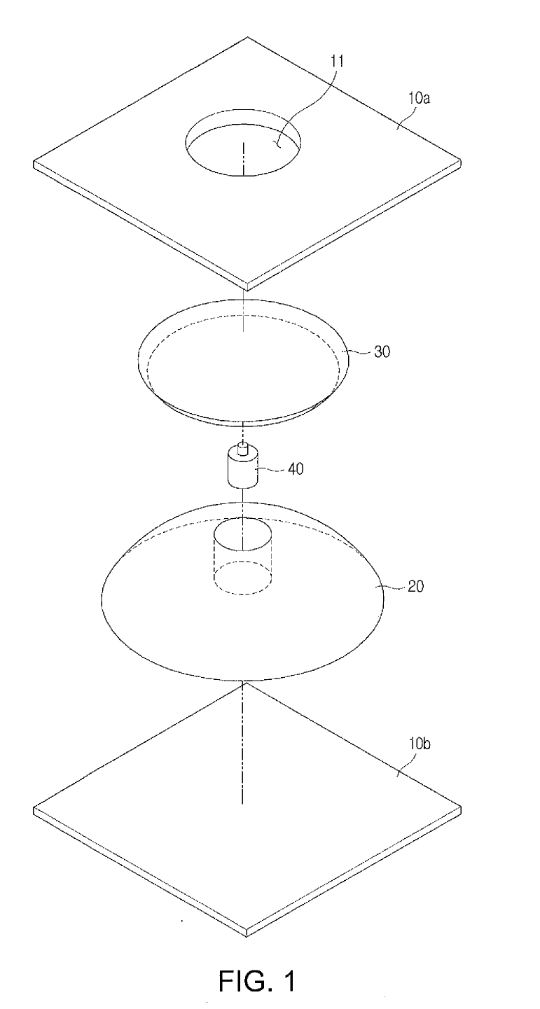

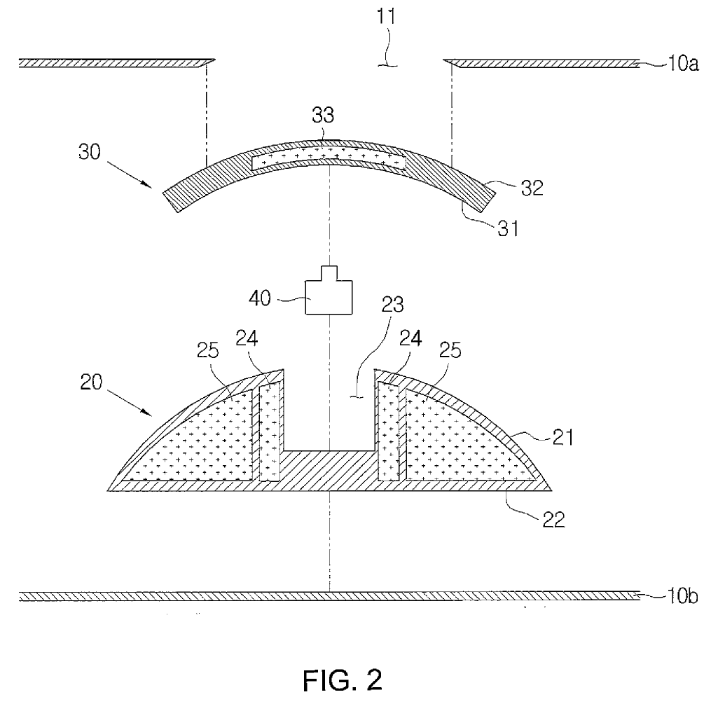

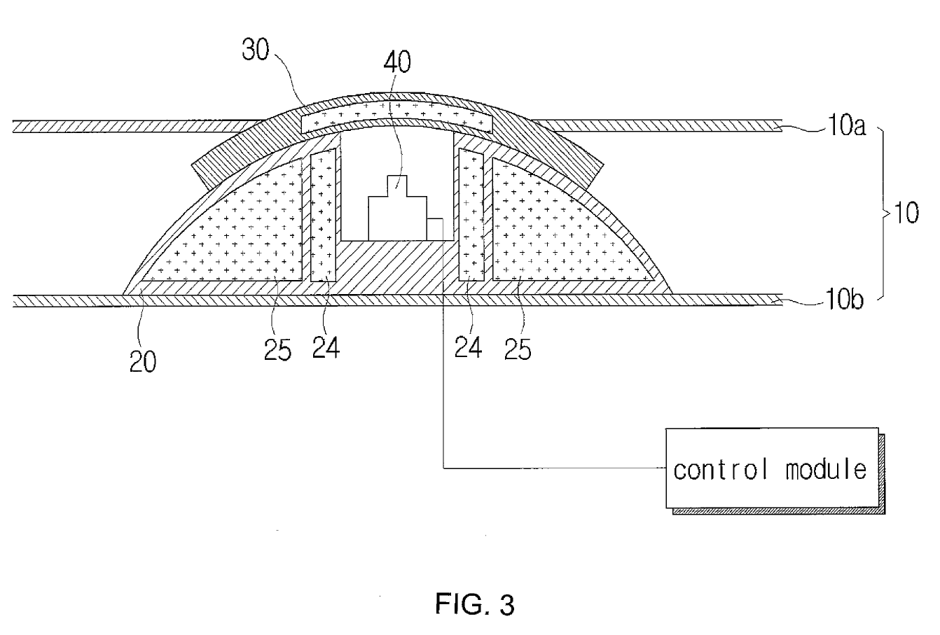

FIG. 1 is an exploded perspective view of a pointing device according to a first exemplary embodiment of the present invention, FIG. 2 is a cross-section view of the pointing device according to the first exemplary embodiment of the present invention, and FIG. 3 is an assembled cross-section view of the pointing device according to the first exemplary embodiment of the present invention.

Referring to FIGS. 1 to 3, the pointing device according to the first exemplary embodiment of the present invention includes a housing main body 10, a curved supporter 20, a pointing unit 30, a sensor 40, and a control module 50.

The housing main body 10 may be an external housing of a general portable computer or an external housing of a mobile device such as a cellular phone or a personal digital assistant (PDA), in which the pointing unit 30, curved supporter 20 and sensor 40 to be described later can be internally installed. Accordingly, the housing main body 10 includes an upper panel 10a and a lower panel 10b which are spaced apart from and face to each other while keeping a certain space therebetween.

The upper panel 10a is formed with a hole 11 in a certain region thereof so that an upper part of the pointing unit 30 to be described later can be exposed to the outside in the certain region.

The curved supporter 20 has a curved surface, e.g., a concave surface or a convex surface. In this exemplary embodiment, the convex surface obtained by cutting a part of a sphere will be described by way of example.

The curved supporter 20, a cut part of a sphere, includes a curved surface 21 of the sphere and a bottom 22 corresponding to a section. Also, the curved supporter 20 may be internally provided with a sensor receiving part 23 in the form of a groove opened upward so that the sensor 40 to be described later is accommodated and received. At this time, the sensor receiving part 23 may be formed in the middle of the curved supporter 20. Alternatively, the sensor receiving part 23 may be provided in the form of a hole.

In the meantime, a magnetic unit includes a first magnetic unit 24 installed in a region adjacent to the sensor receiving part 23, a second magnetic unit 25 installed outside the adjacent region, and a third magnetic unit 33 embedded in the pointing unit 30 to be described later.

Inside the curved supporter 20, the first magnetic unit 24 and the second magnetic unit 25 of the magnetic unit are installed from the adjacent region of the sensor receiving part 23 up to the vicinity of the curved surface 21 and the vicinity of the bottom 22. At this time, the first magnetic unit 24 and the second magnetic unit 25 may be opposite to each other in magnetic polarity.

For instance, if the polarity of the first magnetic unit 24 is N between N and S, the polarity of the second magnetic unit 25 is S. On the other hand, if the polarity of the first magnetic unit 24 is S, the polarity of the second magnetic unit 25 is N.

Thus, the first magnetic unit 24 and the second magnetic unit 25 are installed to be opposite to each other in the magnetic polarity and interact with the third magnetic unit 22 installed in the pointing unit 30 to be described later, so that the pointing unit 30 can return to an original position after sliding along the curved supporter 20.

With this curved supporter 20, the bottom 22 may be coupled to a top of the lower panel 10b of the housing main body 10 so that the sensor receiving part 23 and the hole 11 of the upper panel 10a can face to each other.

Below, the pointing unit 30 will be described. The pointing unit 30 is configured to have a certain thickness and to cover the sensor receiving part 23 of the curved supporter 20. Here, the pointing unit 30 may be shorter or longer than an arc of the curved surface 21. For example, the pointing unit 30 may be shorter than the arc of the curved surface 21 (e.g., shorter than an arc from the top to the left or right end of the curved supporter 20).

Also, a pointing moving part 31, the bottom of the pointing unit 30, may be shaped corresponding to the curved surface 21 so that it can slide along the curved surface 21 of the curved supporter 20. In other words, the pointing moving part 31 may be formed spherically and concentrically with regard to the curved surface 21.

Further, a top surface 32 of the pointing unit 30 may be curved to smoothly contact the upper panel 10a when the pointing moving part 31 slides along the curved surface 21 while supported by the upper panel 10a of the housing main body 10. For example, the top surface 32 may be formed spherically and concentrically with regard to the pointing moving part 31.

Here, the pointing unit 30 may be internally embedded with the third magnetic unit 33 made of the same material as the first magnetic unit 24 and the second magnetic unit 25 of the curved supporter 20.

The polarity of the third magnetic unit 33 is opposite to that of the first magnetic unit 24 of the curved supporter 20 to thereby exert an attractive force, but is the same as that of the second magnetic unit 25 to thereby exert a repulsive force, so that the pointing unit 30 can return to its original position after sliding along the curved surface 21 of the curved supporter 20.

Also, the pointing unit 30 is installed on the top of the curved supporter 20, so that the magnetic forces of the first and second magnetic units 24 and 25 and the third magnetic unit 33 respectively installed in the curved supporter 20 and the pointing unit 30 can interact with one another, and the pointing unit 30 can be placed in the center of the curved supporter 20, i.e., above the sensor receiving part 23.

At this time, the upper panel 10a of the housing main body 10 supports the pointing unit 30, so that the pointing unit 30 can be more stably placed on the top of the curved supporter 20.

Further, an upper part of the pointing unit 30 is partially exposed through the hole 11 formed in the upper panel 10a of the housing main body 10. Therefore, when a user applies an external force to the pointing unit 30 in one direction, the pointing unit 30 can slide along the curved surface 21 of the curved supporter 20.

Next, the sensor 40 and the control module 50 will be described. The sensor 40 may be installed to sense the movement of the pointing moving part 31 of the pointing unit 30 sliding along the curved surface 21 of the curved supporter 20 while being accommodated and received in the sensor receiving part 23 of the curved supporter 20. Here, the sensor 40 may be installed to sense one spot, i.e., one point of the pointing moving part 31, but not limited thereto. Alternatively, a plurality of sensors may be installed and used in the sensing.

Since the sensor 40 is installed to sense the pointing moving part 31 not exposed to the outside of the pointing unit 30, there is effect on improving the conventional problem that occurs when the exposed part of the ball is sensed.

The control module 50 may be connected to the sensor 40 and receive the movement of the pointing moving part 30 sensed by the sensor 40, thereby displaying the movement of the pointing unit 30 on a screen through a predetermined algorithm. For example, the control module 50 may be configured to move a mouse pointer on the screen may be moved corresponding to the movement of the pointing moving part 30.

At this time, the control module 50 may be configured not to move the mouse pointer if the pointing unit 30 returns to its original position by the attractive force between the first magnetic unit 24 of the curved supporter 20 and the third magnetic unit 33 of the pointing unit 30 and the repulsive force between the second magnetic unit 25 of the curved supporter 20 and the third magnetic unit 33 of the pointing unit 30, after the pointing unit 30 slides along the curved surface 21.

In the first exemplary embodiment, the pointing unit is configured to slide by the magnetic unit along the curved surface of the curved supporter, but not limited thereto. In an alternative exemplary embodiment, the pointing unit may be configured to be elastically restored after moved.

With this configuration, the pointing device according to the first exemplary embodiment can not only achieve a delicate movement of a mouse pointer as a merit of the conventional ball mouse, but also be installed within a limited space such as a portable device.

Now, the operation of the foregoing pointing device according to the first exemplary embodiment will be described.

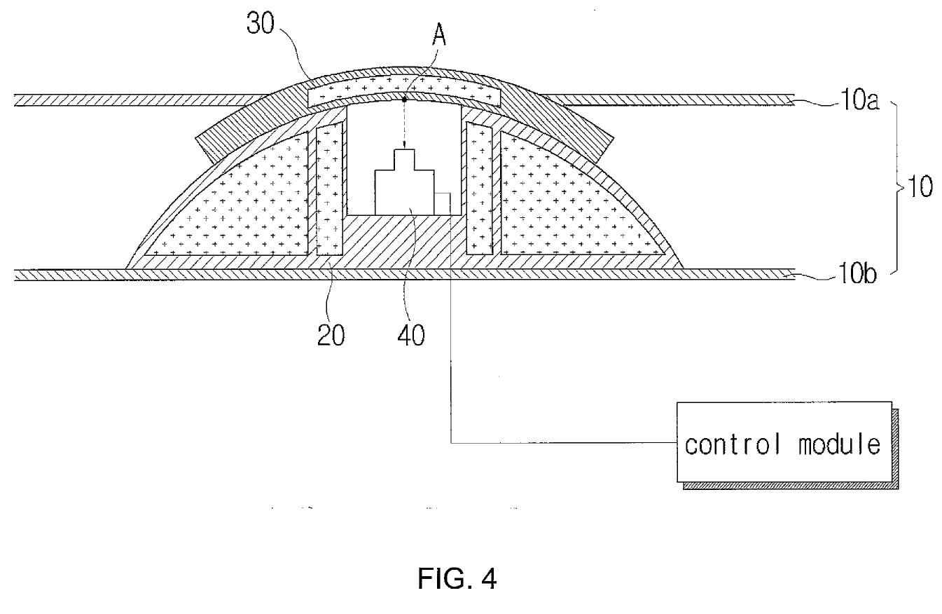

FIGS. 4 through 6 show the operation of the pointing device according to the first exemplary embodiment of the present invention. Referring to FIGS. 4 through 6, the sensor 40 senses an A point in an initial state before the pointing unit 30 is moved as shown in FIG. 4.

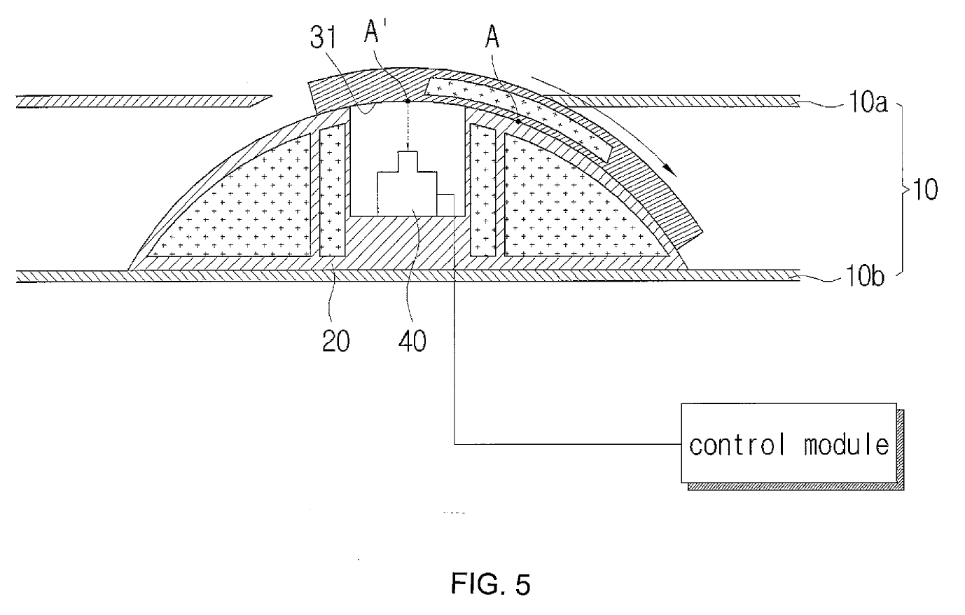

Then, as shown in FIG. 5, if a user exerts a predetermined force to the pointing unit 30 in a right direction, the pointing unit 30 moves along the curved surface 21 and at this time the sensor 40 senses an A′ point. In other words, the pointing unit 30 slides and moves from the A point to the A′ point along the curved surface 21, and the sensor 40 senses each point of the pointing moving part 31 from the A point to the A′ point while transmitting a sensed signal to the control module 50. At the same time, the control module 50 that receives the sensed signal from the sensor 40 moves the mouse pointer on the screen, corresponding to the sliding of the pointing unit 30 on the basis of a predetermined algorithm.

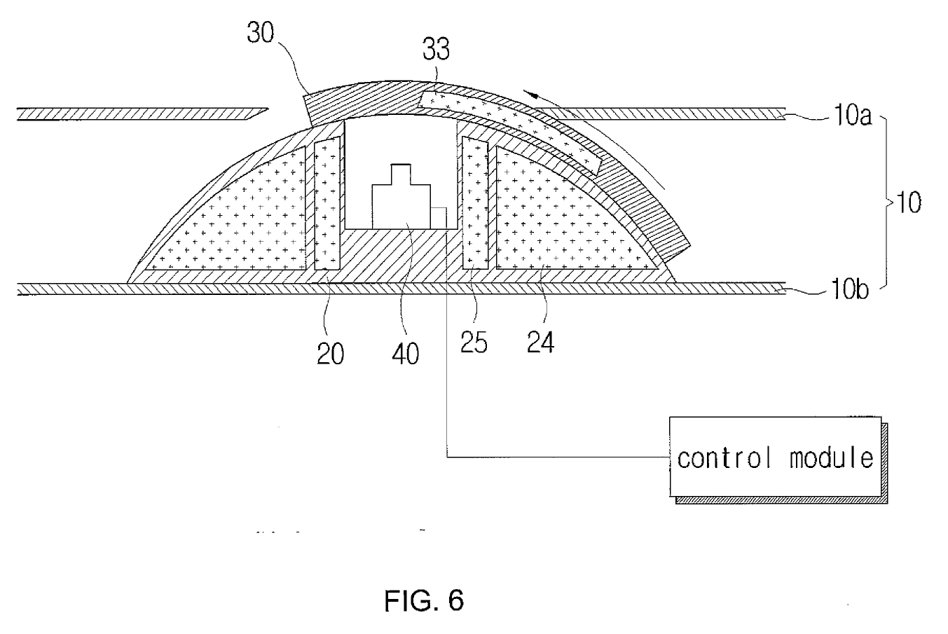

Thereafter, if a user releases the force from the pointing unit 30, as shown in FIG. 6, the first magnetic unit 24 of the curved supporter 20 and the third magnetic unit 33 of the pointing unit 30 are opposite to each other in magnetic polarity to exert the attractive force, but the second magnetic unit 25 of the curved supporter 20 and the third magnetic unit 33 of the pointing unit 30 have the same magnetic polarity to exert the repulsive force, thereby returning the pointing unit 30 to its original position.

At this time, the upper panel 10a is placed above and supports the pointing unit 30 so that the pointing unit 30 can smoothly return to its original position.

Meanwhile, the control module 50 does not move the mouse pointer on the screen when the pointing unit 30 returns to its original position by the first and third magnetic units 24 and 33.

In any direction other than the foregoing direction, where a user applies the force to the pointing unit 30 and makes it slide, the same method may be used for moving the mouse pointer on the screen.

Thus, it is possible to move the mouse pointer by sensing a part not exposed to the outside, so that the sensor 40 can be improved in malfunction and life.

Further, the curved surface may be not only changed in curvature to be applied corresponding to various sizes, but also designed to be suitable for the housing main body of the mobile device that requires thin thickness.

As described above, there is provided a pointing device that can be installed within a limited space.

Also, there is provided a pointing device that can move a mouse pointer minutely.

Further, there is provided a pointing device suitable for a small portable computer, a cellular phone, a PDA, or etc. since it can move a mouse pointer minutely within a limited space.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As a pointing device making a sense of delicate movement possible without a separate mouse can be installed in various portable devices such as a notebook computer, a personal digital assistant (PDA), a mobile device, etc. that have recently become gradually miniaturized and are stressed on portability, it is possible to provide a user with the pointing device having high sensibility and provide convenience of the portable device to a worker or the like needing minute movement.

What is claimed is:

1. A pointing device comprising:
a curved supporter which comprises a curved surface;
a pointing unit which is placed over the curved supporter and slides along the curved surface of the curved supporter; and
a sensor which senses movement of the pointing unit,
the movement of the pointing unit being displayed on a screen, corresponding to extent that the pointing unit slides along the curved surface of the curved supporter.

2. The pointing device according to claim 1, further comprising a housing main body in which the curved supporter, the pointing unit and the sensor are embedded.

3. The pointing device according to claim 1, wherein the sensor senses movement of a pointing moving part that is a bottom of the pointing unit.

4. The pointing device according to claim 1, wherein the pointing unit or the curved supporter comprises a magnetic unit or a spring so that the pointing unit returns to an original position after moved by sliding along the curved surface of the curved supporter.

5. The pointing device according to claim 1, wherein the curved supporter comprises a sensor receiving part to accommodate the sensor.

6. The pointing device according to claim 5, wherein the sensor receiving part comprises one of a hole and a groove.

7. The pointing device according to claim 6, further comprising a control module provided to display the movement of the pointing unit on the screen, corresponding to the extent that the pointing unit slides along the curved surface of the curved supporter.

8. The pointing device according to claim 5, further comprising a control module provided to display the movement of the pointing unit on the screen, corresponding to the extent that the pointing unit slides along the curved surface of the curved supporter.

9. The pointing device according to claim 4, further comprising a control module provided to display the movement of the pointing unit on the screen, corresponding to the extent that the pointing unit slides along the curved surface of the curved supporter.

10. The pointing device according to claim 3, further comprising a control module provided to display the movement of the pointing unit on the screen, corresponding to the extent that the pointing unit slides along the curved surface of the curved supporter.

11. The pointing device according to claim 2, further comprising a control module provided to display the movement of the pointing unit on the screen, corresponding to the extent that the pointing unit slides along the curved surface of the curved supporter.

12. The pointing device according to claim 1, further comprising a control module provided to display the movement of the pointing unit on the screen, corresponding to the extent that the pointing unit slides along the curved surface of the curved supporter.
